(19) United States
(12) Patent Application Publication
(10) Pub. No.: US 2013/0062035 A1
(43) Pub. Date: Mar. 14, 2013

(54) SUBSTRATE COOLING DEVICE, SUBSTRATE COOLING METHOD AND HEAT TREATMENT APPARATUS

(71) Applicants: Masato Kawakami, Tsukuba-shi (JP); Hiromi Nitadori, Oshu-shi (JP); Yun Mo, Tsukuba-shi (JP)

(72) Inventors: Masato Kawakami, Tsukuba-shi (JP); Hiromi Nitadori, Oshu-shi (JP); Yun Mo, Tsukuba-shi (JP)

(73) Assignee: TOKYO ELECTRON LIMITED, Tokyo (JP)

(21) Appl. No.: 13/597,513

(22) Filed: Aug. 29, 2012

(30) Foreign Application Priority Data
Sep. 12, 2011 (JP) 2011-198604

(51) Int. Cl. F27D 9/00; F24F 7/00

(52) U.S. Cl. 165/59; 432/65

(57) ABSTRACT

A substrate cooling device includes a cylindrical heat shielding member 30 configured to be movable between an insertion position where the heat shielding member 30 is inserted between the substrate holding member 15 in a processing vessel 11 and a heating member 12 and an unloading position where the heat shielding member 30 is unloaded from the insertion position, and configured to block radiant heat toward the substrates W after completing a heat treatment; and an air cooling port 21 provided at an outside of the processing vessel 11. The heat shielding member 30 includes two half-cylindrical members 31 that are assembled and separated at the unloading position, and is movable between the unloading position and the insertion position. An outer surface and an inner surface of the heat shielding member 30 are made of materials having a relatively low emissivity and a relatively high emissivity, respectively.

### CROSS-REFERENCE TO RELATED APPLICATION

This application claims the benefit of Japanese Patent Application No. 2011-198604 filed on Sep. 12, 2011, the disclosures of which are incorporated herein by reference.

### FIELD OF THE INVENTION

The present disclosure relates to a substrate cooling method and a substrate cooling device for cooling a substrate after the substrate is heat-treated. The present disclosure also relates to a heat treatment apparatus having the substrate cooling device.

### BACKGROUND OF THE INVENTION

When performing a heat treatment such as a diffusion process, a film forming process or an oxidation process on a substrate such as a semiconductor wafer, there has been widely used a batch-type vertical heat treatment apparatus. In this heat treatment apparatus, a boat made of quartz and configured to accommodate therein a multiple number of substrates in multi-levels in a vertical direction is loaded into a vertical processing vessel made of quartz. The substrates are heated by a cylindrical resistance heater disposed around the processing vessel.

In such a vertical heat treatment apparatus, a loading area as a substrate transfer chamber is provided under the processing vessel. A multiple number of substrates are loaded onto the boat in this loading area, and then, transferred into the processing vessel to be subjected to a heat treatment. After the completion of the heat treatment, the substrates loaded on the boat are transferred back into the loading area, and then, unloaded from the boat. At this time, since a temperature of the substrate has a range from, e.g., about 500° C. to about 1200° C., a temperature of the loading area also becomes high. There is known a technique for cooling this loading area by supplying a cooling gas to the vicinity of an opening (furnace throat) of the loading area (see, for example, Patent Document 1).

Patent Document 1: Japanese Patent Laid-open Publication No. 2002-176045

Even if, however, the cooling gas is supplied into the loading area, it has been difficult to effectively decrease the temperature of the substrate, which has been heated to the high temperature. Accordingly, it takes time to cool the substrates sufficiently, and a throughput of the process is reduced.

Further, in order to improve the cooling effect, the cooling gas may be supplied in a large quantity. Usually, however, since the multiple number of substrates are accommodated in the boat with a small gap therebetween, the cooling gas is supplied from a lateral side thereof. Accordingly, the surface of a substrate may not be cooled uniformly. As a result, a temperature of the substrate may be non-uniformly distributed. Further, due to a difference in thermal expansion of the substrate, the substrate may be bent and more easily damaged. Especially, the problem of the non-uniform temperature distribution of the substrate is getting worse as the substrate is getting scaled up.

### BRIEF SUMMARY OF THE INVENTION

In view of the foregoing, illustrative embodiments provide a substrate cooling method and a substrate cooling device capable of cooling a substrate rapidly after the substrate is heat-treated in a batch-type heat treatment apparatus for heating a multiple number of substrates and, also, capable of cooling the substrate uniformly even if the substrate has a large size. Further, the illustrative embodiments also provide a heat treatment apparatus having the substrate cooling device.

In accordance with one aspect of an illustrative embodiment, there is provided a substrate cooling device for cooling a multiple number of substrates heat-treated in a heat treatment apparatus. The heat treatment apparatus includes a substrate holding member for holding the substrates; a processing vessel for accommodating the substrate holding member therein; a heating member disposed to surround the substrate holding member and to heat the substrates by radiant heat; and an elevating device for moving the substrate holding member between an inside of the processing vessel and an outside of the processing vessel. Further, the heat treatment apparatus performs a heat treatment on the substrates held on the substrate holding member by the heating member. The substrate cooling device includes a cylindrical heat shielding member configured to be movable between an insertion position where the heat shielding member is inserted between the substrate holding member and the heating member and an unloading position where the heat shielding member is unloaded from the insertion position, and configured to block radiant heat toward the substrates after completing the heat treatment; and an air cooling port provided at the outside of the processing vessel. The heat shielding member includes two half-cylindrical members that are assembled and separated at the unloading position, and the two half-cylindrical members are movable between a retreat position where the two half-cylindrical members are separately positioned apart from each other and an assembly position where the two half-cylindrical members are assembled to form the cylindrical heat shielding member. Further, the heat shielding member assembled at the assembly position is moved between the unloading position and the insertion position. Moreover, an outer surface of the heat shielding member is made of a material having a relatively low emissivity and an inner surface of the heat shielding member is made of a material having a relatively high emissivity.

The air cooling port may have a cooling gas supply device configured to supply a cooling gas to the substrate holding member. The substrate cooling device may further include supporting members for respectively supporting the half-cylindrical members of the heat shielding member, and heat of the half-cylindrical members may be discharged via the supporting members when the assembled half-cylindrical members are inserted between the heating member and the substrate holding member within the processing vessel. The supporting members may be made of aluminum nitride or alumina. The material having the relatively low emissivity for forming the outer surface of the heat shielding member may be quartz or tungsten, and the material having the relatively high emissivity for forming the inner surface of the heat shielding member may be aluminum nitride or alumina.

A length of the heat shielding member may be set so as not to hinder a supply of the cooling gas from the cooling gas supply device when the heat shielding member is unloaded to the unloading position. Further, the heat shielding member may have one or more holes through which the cooling gas from the cooling gas supply device passes, so that the cooling gas is supplied to the substrates held on the substrate holding member. Here, the one or more holes may be formed only at a region of the heat shielding member that obstructs the supply of the cooling gas from the cooling gas supply device.

In accordance with another aspect of the illustrative embodiment, there is provided a substrate cooling method for cooling a multiple number of substrates heat-treated in a heat treatment apparatus. The heat treatment apparatus includes a substrate holding member for holding the substrates; a processing vessel for accommodating the substrate holding member therein; a heating member disposed to surround the substrate holding member and to heat the substrates by radiant heat; and an elevating device for moving the substrate holding member between an inside of the processing vessel and an outside of the processing vessel. The heat treatment apparatus performs a heat treatment on the substrates held on the substrate holding member by the heating member. The substrate cooling method includes inserting a cylindrical heat shielding member between the substrate holding member within the processing vessel and the heating member after completing the heat treatment, the cylindrical heat shielding member including an outer surface made of a material having a relatively low emissivity, and an inner surface made of a material having a relatively high emissivity; performing radiative cooling of the heat-treated substrates held on the substrate holding member by blocking radiant heat toward the substrate; unloading the substrate holding member into an air cooling port provided at the outside of the processing vessel; and performing air cooling of the substrates.

In accordance with still another aspect of the illustrative embodiment, there is provided a heat treatment apparatus including a substrate holding member configured to hold a multiple number of substrates; a processing vessel configured to accommodate the substrate holding member therein; a heating member disposed to surround the substrate holding member and configured to heat the substrates by radiant heat; an elevating device configured to move the substrate holding member between an inside of the processing vessel and an outside of the processing vessel; and a substrate cooling device configured to cool the substrates after performing a heat treatment on the substrates. The substrate cooling device includes a cylindrical heat shielding member configured to be movable between an insertion position where the heat shielding member is inserted between the substrate holding member and the heating member and an unloading position where the heat shielding member is unloaded from the insertion position, and configured to block radiant heat toward the substrates after completing the heat treatment; and an air cooling port provided at the outside of the processing vessel. Here, the heat shielding member includes two half-cylindrical members that are assembled and separated at the unloading position. The two half-cylindrical members are movable between a retreat position where the two half-cylindrical members are separately positioned apart from each other and an assembly position where the two half-cylindrical members are assembled to form the cylindrical heat shielding member, and the heat shielding member assembled at the assembly position is moved between the unloading position and the insertion position. Further, an outer surface of the heat shielding member is made of a material having a relatively low emissivity and an inner surface of the heat shielding member is made of a material having a relatively high emissivity.

In accordance with the illustrative embodiment, after performing the heat treatment, the cylindrical heat shielding member is inserted between the substrate holding member and the heating member within the processing vessel. Accordingly, the radiant heat from the heating member to the substrate can be blocked and radiant heat from the substrate can be absorbed. Thus, in a high temperature state, the substrate can be effectively cooled by the radiative cooling. Further, since the outer surface of the heat shielding member is made of the material having the relatively low emissivity, the radiant heat from the heating member is reflected and the amount of the radiant heat reaching the substrate can be reduced. Further, since the inner surface of the heat shielding member is made of the material having the relatively high emissivity, the effect of absorbing the radiant heat from the substrate can be improved. When the substrate holding member is cooled after unloaded to the air cooling port, since the temperature of the substrate is decreased by the radiative cooling, the substrate can be cooled effectively by the convective cooling, and the time during which the substrate is not efficiently cooled by the air cooling can be reduced. Moreover, after unloaded to the unloading position from the insertion position, the heat shielding member is separated into the two half-cylindrical members and retreated to the retreat position. Thus, the heat shielding member neither hinders the air cooling of the substrate nor obstructs the loading/unloading operation of the substrate holding member. Furthermore, unlike a rapid cooling method for cooling the substrate by using a large quantity of cooling gas or the like, a temperature distribution within the surface is relatively uniform even if the size of the substrate is large. Thus, the substrate can be cooled uniformly.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a longitudinal cross sectional view illustrating a heat treatment apparatus in accordance with an illustrative embodiment;

FIG. 2 is a transversal cross sectional view showing a loading area of the heat treatment apparatus of FIG. 1;

FIG. 3 is a longitudinal cross sectional view taken along a line A-A of FIG. 1;

FIG. 4 is a perspective view illustrating a heat shielding member;

FIG. 5 is a cross sectional view showing the heat shielding member;

FIG. 6 is a diagram for describing a sequence for assembling the heat shielding member;

FIG. 7 is a diagram for describing a sequence for retreating the heat shielding member; and

FIG. 8 is a diagram illustrating a modification example of the heat shielding member.

### DETAILED DESCRIPTION OF THE INVENTION

Hereinafter, illustrative embodiments will be described in detail with reference to the accompanying drawings.

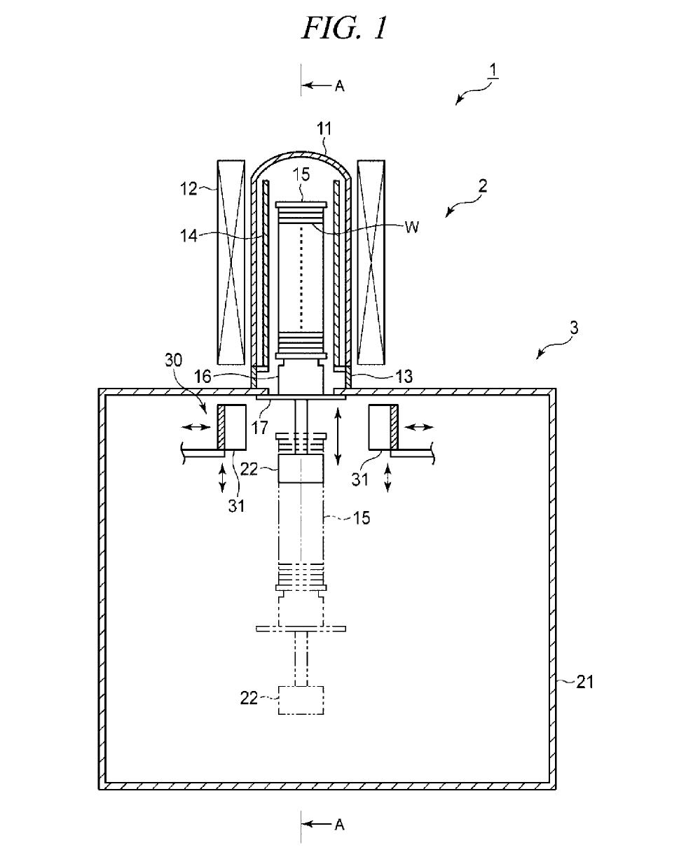

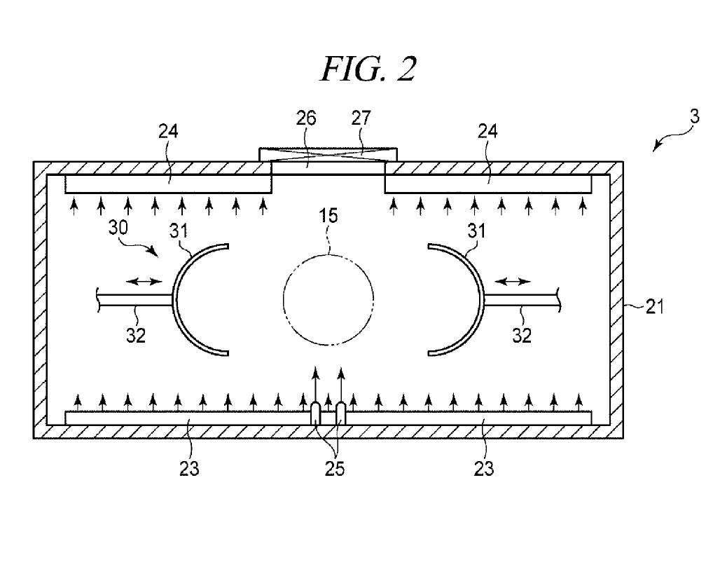

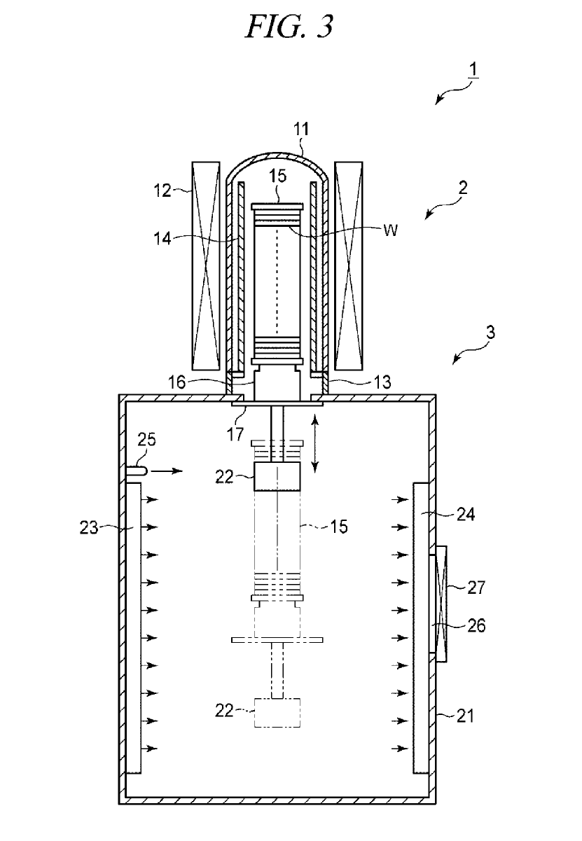

FIG. 1 is a longitudinal cross sectional view illustrating a heat treatment apparatus in accordance with an illustrative embodiment. FIG. 2 is a transversal cross sectional view illustrating a loading area as a substrate transfer chamber of the heat treatment apparatus of FIG. 1. FIG. 3 is a longitudinal cross sectional view taken along a line A-A of FIG. 1.

As illustrated in FIG. 1, the heat treatment apparatus 1 is configured to perform various types of heat treatments such as a diffusion process, an oxidation process and a film forming process on a multiple number of semiconductor wafers W (hereinafter, simply referred to as “wafers”) as substrates. The heat treatment apparatus 1 includes a heat treating area 2 where these heat treatments are performed; and a loading area (substrate transfer chamber) 3 where the wafers W are loaded into or unloaded from the heat treating area 2.

The heat treating area 2 includes a vertical processing vessel 11 having a vertically elongated cylinder shape. A main part of the processing vessel 11 is made of a heat resistant material such as quartz. A cylindrical metal manifold 13 is provided under the main part of the processing vessel 11. A processing gas supply line and an exhaust line (both are not shown) are connected to the manifold 13 so that the processing gas is supplied into the processing vessel 11 and an inside of the processing vessel 11 is evacuated. A cylindrical heater unit 12 composed of resistance heaters as a heating member is provided around the processing vessel 11. Further, an inner tube 14 made of quartz is disposed within the processing vessel 11. That is, the processing vessel 11 has a dual tube structure. Furthermore, the heating member may not be limited to the resistance heater and any type of heating member can be used as long as the heating member heats a substrate by radiant heat. In addition, the heating member may not be provided at the outside of the processing vessel 11 but can be provided at the inside of the processing vessel 11 as long as the heating member is positioned so as to surround the substrate.

A wafer boat 15, as a substrate holding member, made of quartz is loaded into the inner tube 14 of the processing vessel 11 while holding thereon a multiple number of wafers W stacked in a vertical direction. After the inside of the processing vessel 11 is set to be a depressurized atmosphere, a heat treatment such as a diffusion process, a film forming process or an oxidation process is performed on the substrate.

The loading area 3 includes a housing 21, and an elevating member 22 for supporting and elevating the wafer boat 15 is disposed within the housing 21. The elevating member 22 is moved up and down by an elevating device (not shown), so that the wafer boat 15 can be moved up and down between a wafer transfer position (indicated by a double dashed line) within the housing 21 and a processing position (indicated by a solid line) within the processing vessel 11.

The wafer boat 15 is supported by the elevating member 22 via a heat insulating tube 16 and a lid 17. The elevating member 22 is moved down by the elevating device, and the wafer boat 15 is positioned within the housing 21 of the loading area 3. At this state, wafers W are transferred between the wafer boat 15 and a wafer carrier (not shown) by a transferring device (not shown).

The wafers W are moved to and loaded on the wafer boat 15 from the wafer carrier by the transferring device. After a multiple number of, e.g., about 50 sheets to about 150 sheets of wafers W are loaded on the wafer boat 15, the elevating member 22 is moved upward by the elevating device. As a result, the wafer boat 15 accommodating therein the wafers W is loaded into the processing vessel 11, as shown in FIG. 1. In this state, the lid 17 is configured to close an opening corresponding to a bottom opening of the processing vessel 11 and a top opening of the housing 21 and configured to hermetically seal the inside of the processing vessel 11. Then, the processing vessel 11 is evacuated and a processing gas is supplied into the processing vessel 11. The wafers W loaded on the wafer boat 15 are heated to a high temperature of, e.g., about 500° C. to about 1200° C. by the heater unit 12, and a heat treatment such as a diffusion process, a film forming process or an oxidation process is performed. After the heat treatment is performed in the processing vessel 11, the wafer boat 15 is moved down into the housing 21 of the loading area 3 by the elevating device along with the elevating member 22, the lid 17 and the heat insulating tube 16 so as to be air-cooled therein. That is, the housing 21 of loading area 3 serves as an air-cooling port as a part of a substrate cooling device for cooling the wafers W as substrates.

After the wafer boat 15 is returned back into the housing 21, the processed wafers W within the wafer boat 15 are transferred back into the wafer carrier by the transferring device. After the wafer boat 15 is unloaded from the processing vessel 11 into the loading area 3, the bottom opening of the processing vessel 11 is closed by a shutter (not shown). Accordingly, heat from the processing vessel 11 into the loading area 3 is blocked, so that the wafer W can be cooled without being interrupted.

As depicted in FIGS. 2 and 3, a fan filter unit (FFU) for supplying a clean gas such as a N₂ gas; and an exhaust unit 24 for exhausting the clean gas which has been rectified are provided within the housing 21 of the loading area 3. Further, for example, two cooling gas supply nozzles 25 are provided above the FFU 23. The cooling gas supply nozzles 25 discharge a cooling gas such as a N₂ gas toward the wafer boat 15. At this time, the wafer boat is being moved downward into the housing 21 from the processing vessel 11 after the heat treatment is completed. The cooling gas supply nozzles 25 serve as a part of the substrate cooling device for cooling the wafers W as the substrates after the heat treatment is completed. Further, the housing 21 has a loading/unloading opening 26 through which the wafer carrier is loaded into and unloaded from the housing 21. The loading/unloading opening 26 is opened and closed by a shutter 27.

The heat treatment apparatus 1 includes the aforementioned substrate cooling device for cooling the wafers W as the substrates after the heat treatment is finished. As mentioned above, the substrate cooling device includes the housing 21 of the loading area 3 serving as the air-cooling port; and the cooling gas supply nozzle 25. Beside these components, the substrate cooling device further includes, as a major component, a heat shielding member 30 configured to be inserted between the heater unit and the wafer boat 15 within the processing vessel 11 upon the completion of the heat treatment of the wafers W to prevent heat from the heater unit 12 from being directed toward the wafers W. The heat shielding member 30 blocks the heat from the heater unit 12 so that the cooling of the wafers W as the substrates can be accelerated. The heat shielding member 30 is configured to be movable between an insertion position between the heater unit 12 and the wafer boat 15 within the processing vessel 11 and an unloading position in the upper region of the housing 21 of the loading area 3.

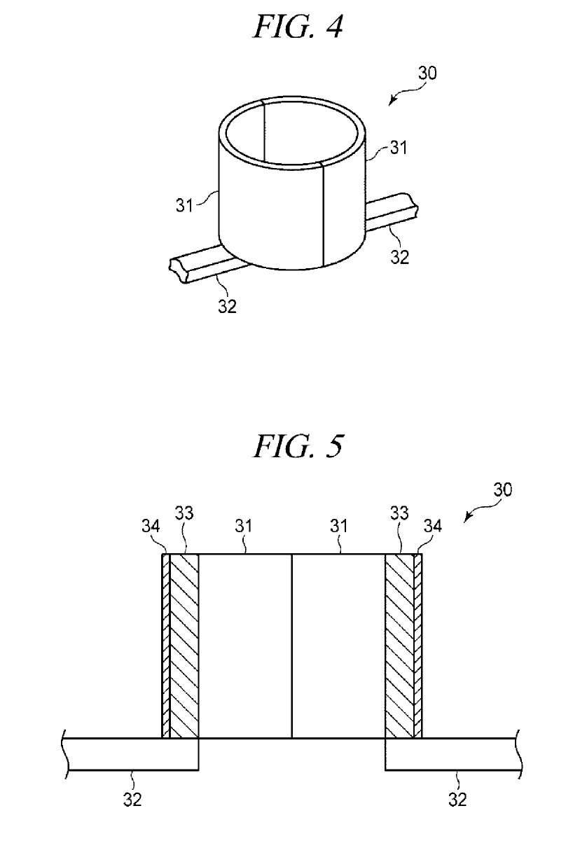

The heat shielding member 30 includes two half-cylindrical members 31. As depicted in FIG. 4, these two half-cylindrical members 31 are assembled to form a cylinder shape. Arms 32, as supporting members, configured to support the half-cylindrical members 31 are connected to bottom ends of the two half-cylindrical members 31. At the unloading position, each of the two half-cylindrical members is moved by a driving device (not shown) between a retreat position where the two half-cylindrical members 31 are outwardly distanced apart from each other and an assembly position where the two half-cylindrical members 31 are assembled so as to provide the heat shielding function via the arms 32. Further, after the two half-cylindrical members 31 are assembled into the cylindrical heat shielding member 30 at the assembly position, the heat shielding member 30 is moved up and down between the unloading position and the insertion position by the driving device. Here, the connecting position of the arm 32 may not be limited to the bottom end of the half-cylindrical member.

The half-cylindrical members 31 of the heat shielding member 30 have a dual structure. That is, each of two half-cylindrical members 31 has an inner member 33 as an inner surface of the half-cylindrical member 31 and an outer member 34 as an outer surface thereof. The inner member 33 and the outer member 34 are formed as a single body. The inner member 33 is made of a heat resistant material having a relatively high emissivity, e.g., aluminum nitride (AlN) or alumina (Al₂O₃) in order to readily absorb radiant heat from the wafers W (wafer boat 15). Meanwhile, the outer member 34 is made of a heat resistant material having a relatively low emissivity (i.e., high reflectivity), e.g., quartz or tungsten (W) in order to block heat radiation from the heater unit. The inner member 33 and the outer member 34 may be bonded or attached to each other by an appropriate method, or the outer member 34 may be formed on the inner member 33 by an appropriate film forming method.

Further, the arms 32 have a function of discharging the heat absorbed by the heat shielding member 30. Desirably, the arms 32 are made of a heat resistant material having a relatively high thermal conductivity, e.g., aluminum nitride (AlN) or alumina (Al₂O₃). To efficiently discharge the heat, it is desirable that the inner member 33, the outer member 34 and the arm 32 be formed as a single body.

In accordance with the present illustrative embodiment, in the upper region of the housing 21, the two half-cylindrical members 31 are assembled to form the cylindrical heat shielding member 30, and the heat shielding member 30 is inserted between the inner tube 14 and the wafer boat 15. The lid 17 has a hole (not shown) through which the assembled heat shielding member 30 and the arms 32 can be inserted. Through this hole, the heat shielding member 30 can be moved upward and, afterward, the wafer boat 15 can be moved downward. This hole is closed by a shutter (not shown) during the heat treatment.

Now, an operation of the heat treatment apparatus 1 having the above-described configuration will be explained.

First, the wafer boat 15 is placed at the wafer transfer position in the housing 21 of the loading area 3, and a multiple number of wafers, e.g., about 50 to about 150 sheets of wafers W are loaded on the wafer boat 15 from the wafer carrier by the transferring device.

Then, the wafer boat 15 and the heat insulating tube are moved up with the elevating member 22 by the elevating device and are loaded into the inner tube 14 within the processing vessel 11 through the opening corresponding to the top opening of the housing 21 and the bottom opening of the housing 21. At this time, the top opening of the housing 21 and the bottom opening of the processing vessel 11 are closed by the lid 17 to be isolated from each other. The inside of the processing vessel 11 is maintained at a high temperature ranging from, e.g., about 500° C. to about 1200° C. while being heated by the heater unit 12. In this state, the processing vessel 11 is evacuated to a depressurized atmosphere, and a processing gas is supplied into the processing vessel 11 to perform a heat treatment such as a diffusion process, a film forming process or an oxidation process.

Upon the completion of the heat treatment, the wafer boat 15 is moved down and the wafers W are cooled. In accordance with the illustrative embodiment, before moving down the wafer boat 15 and cooling the wafers W, the heat shielding member 30 is inserted between the heater unit 12 and the wafer boat 15 within the processing vessel 11. As a result, the heat shielding member 30 can block heat from the heater unit 12 toward the wafers W. Accordingly, the cooling of the wafers W may be accelerated.

Conventionally, the cooling of the wafers after the heat treatment has been performed only by air cooling in the loading area. In general, however, as for heat dissipation of an object, heat radiation is dominant at a temperature equal to or higher than about 400° C., whereas convection is dominant at a temperature lower than about 400° C. Thus, in a high temperature state immediately after the wafer boat 15 is unloaded from the processing vessel 11, convective cooling by supplying a cooling gas may hardly contribute to the cooling of substrates. Further, even if a large quantity of cooling gas is supplied in order to improve the cooling effect, only a part of the substrates located at the upstream of the cooling gas flow may be cooled. As a result, a great non-uniform temperature distribution may be formed in the surface of a substrate so that the substrate may be bent and damaged. As a resolution, in accordance with the illustrative embodiment, in order to effectively cool the wafers W by radiative cooling in the high temperature state, the heat shielding member 30 is provided.

That is, to improve radiative cooling effect, two requirements should be satisfied. First, since the wafer W still receives radiant heat from the heater unit 12 even after the completion of the heat treatment, the radiant heat reaching the wafer W from the heater unit 12 should be blocked. Second, the radiant heat emitted from the surface of the wafer W should be absorbed. These two requirements are satisfied by inserting the heat shielding member 30 of a low temperature between the heater unit 12 and the wafer boat 15 within the processing vessel 11 after the heat treatment.

To elaborate, since the heat shielding member 30 is inserted between the heater unit 12 and the wafer boat 15, the heat shielding member 30 blocks the radiant heat from the heater unit 12. Further, the outer member 34 made of the low-emissivity (high-reflectivity) material reduces the absorption of the radiant heat from the heater unit 12, whereas the inner member 33 made of the high-emissivity material readily absorbs the radiant heat from the wafer W (wafer boat 15). In addition, by discharging the heat absorbed by the heat shielding member 30 via the arms 32, the effect of absorbing the radiant heat from the wafer W (wafer boat 15) can be further ameliorated. To discharge the heat efficiently, it may be desirable that the arms 32 be made of a heat resistant material having high thermal conductivity, such as aluminum nitride (AlN) or alumina (Al₂O₃), and the inner member 33, the outer member 34 and the arm 32 be formed as a single body.

With this configuration, when the wafer boat 15 is unloaded from the processing vessel 11 into the loading area 3, the temperature of the wafer W is decreased lower than conventional cases. Accordingly, a time period during which the wafer W is not efficiently cooled by air cooling can be reduced.

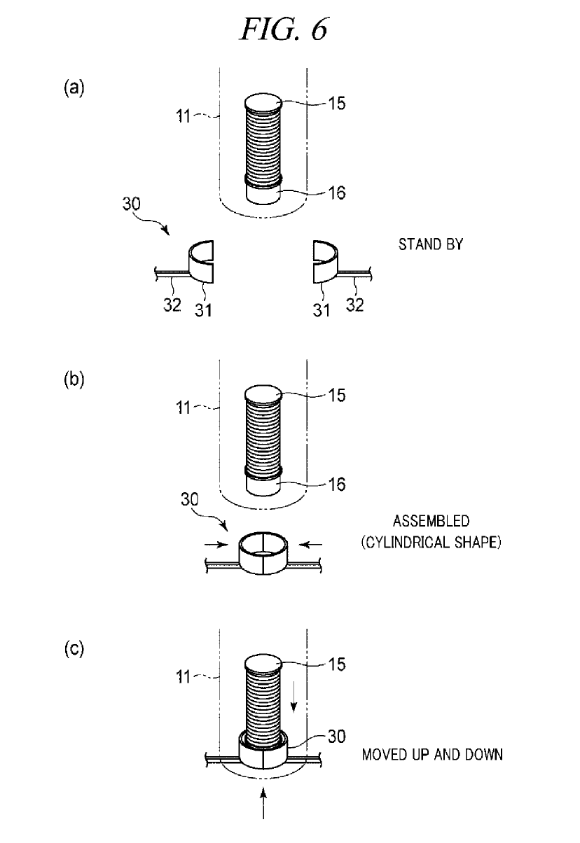

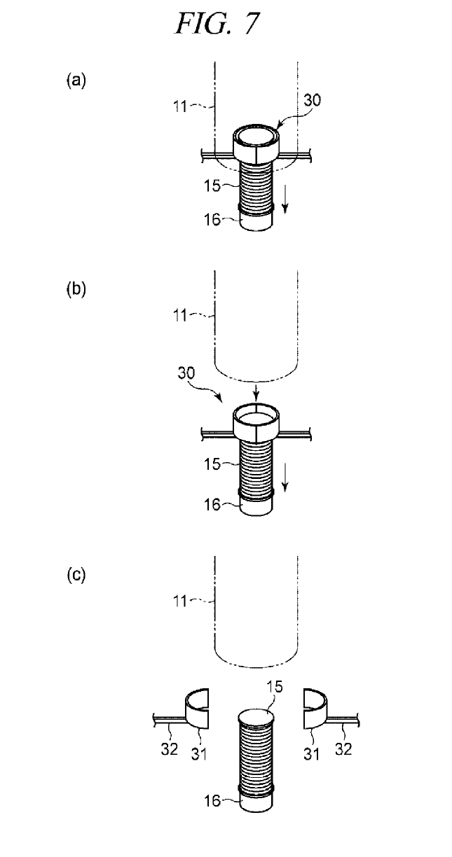

Now, referring to FIGS. 6 and 7, sequences for assembling and retreating the heat shielding member 30 will be explained.

When wafers W are loaded on the wafer boat 15 and when the wafer boat 15 is loaded into the processing vessel 11, the two half-cylindrical members 31 to form the cylindrical heat shielding member 30 are located at the retreat position outwardly distanced apart from each other, as illustrated in FIG. 6(a).

Then, before the cylindrical heat shielding member 30 is inserted into the inner tube 14 of the processing vessel 11 to surround the wafer boat 15, the two half-cylindrical members 31 are horizontally moved and assembled to form the cylindrical heat shielding member 30, as depicted in FIG. 6(b). Upon the completion of a heat treatment, the heat shielding member 30 is inserted into the inner tube 14 to surround the wafer boat 15, as depicted in FIG. 6(c). At the same time of or after inserting the heat shielding member 30, the wafer boat 15 is moved down. Accordingly, radiant heat from the heater unit 12 to the wafer W loaded on the wafer boat 15 can be blocked, and radiant heat from the wafer W can be absorbed. In order to shorten the total processing time, if there is no other process to be performed between the end of the heat treatment and the start of the cooling process, it may be desirable that the operation of preparing the cylindrical heat shielding member 30 by assembling the half-cylindrical members 31 as shown in FIG. 6(b) be completed by the time the heat treatment is ended.

As illustrated in FIG. 7(a), when an upper end of the wafer boat 15 reaches the heat shielding member 30, the heat shielding member 30 is moved downward along with the wafer boat 15, as shown in FIG. 7(b), and taken out of the processing vessel 11 to be located at a certain position within the housing 21. In this state, as depicted in FIG. 7(c), the two half-cylindrical members 31 are horizontally moved outward to be spaced apart from each other and retreated to the retreat position.

As stated above, since the heat shielding member 30 is designed to be retreated after being divided into the two parts, it is possible to allow the heat shielding member 30 not to interrupt the air cooling of the wafer W in the loading area 3 after the heat treatment and is also possible to allow the heat shielding member 30 not to obstruct the loading/unloading of the wafer boat 15.

The length of the heat shielding member 30 may be set so as not to hinder the supply of the cooling gas to the wafer boat when the heat shielding member 30 is moved down into the housing 21 of the loading area 3. Accordingly, until the heat shielding member 30 is retreated to the retreat position after moved down into the housing 21, the cooling gas can be discharged to the wafer boat 15. As a result, it is possible to efficiently carry out the air cooling of the wafer W. Here, as aforementioned above, a large amount of the cooling gas may not be discharged so that a great non-uniform temperature distribution is not formed on the surface of the wafer W.

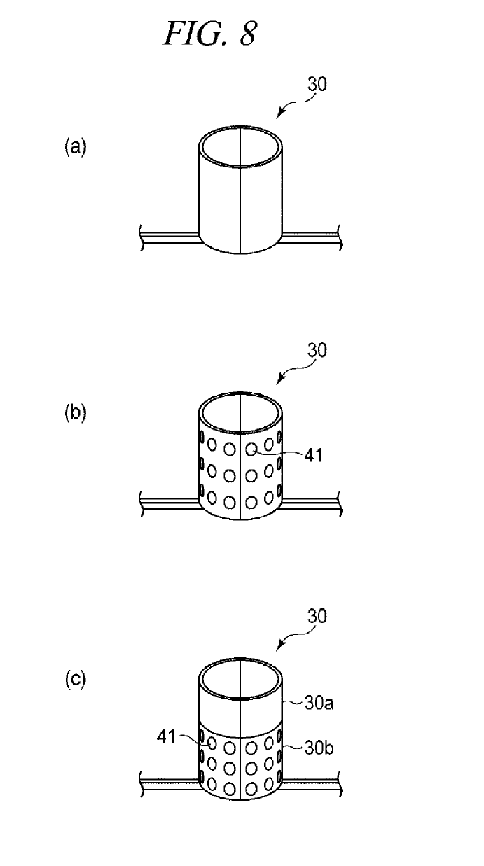

However, the effects of blocking the radiant heat from the heater unit 12 and absorbing the radiant heat from the wafer W (wafer boat 15) by the heat shielding member 30 may be improved as the length of the heat shielding member 30 increases. Thus, if attention is drawn to these effects, it may be desirable to set the length of the heat shielding member 30 to be long, as illustrated in FIG. 8(a). Further, in order to perform the cooling of the wafers W by discharging the cooling gas in the loading area 3 while still achieving the above-mentioned effects of the heat shielding member 30, it may be possible to employ a heat shielding member 30 provided with holes 41, as depicted in FIG. 8(b). That is, when this heat shielding member 30 of FIG. 8(b) is inserted into the processing vessel 11, the region of the heat shielding member 30 of FIG. 8(b) on which the holes 41 are not formed may function as the heat shielding member 30. Meanwhile, when the heat shielding member 30 is returned back into the loading area 3, the cooling gas can be supplied to the wafer W (wafer boat 15) through the holes 41. In the configuration example shown in FIG. 8(b), if the effects of the heat shielding member 30 is not be achieved sufficiently due to the holes 41, the holes 41 may not be formed at an upper portion 30a of the heat shielding member 30 as shown in FIG. 8(c). With this configuration, the aforementioned effects of the heat shielding member 30 can be achieved. Instead, the holes 41 may be formed at a lower portion 30b of the heat shielding member 30, thus allowing the cooling gas to reach the wafer W (wafer boat 15).

The above-described illustrative embodiment is not intended to be limiting and can be modified in various ways. By way of example, in the above illustrative embodiment, although the heat shielding member 30 is inserted between the inner tube 14 of the processing vessel 11 and the wafer boat 15, the illustrative embodiment may not be limited thereto, but the heat shielding member 30 may be inserted between an external wall of the processing vessel 11 and the inner tube 14 or between the heater unit 12 and the external wall of the processing vessel 11. In order to achieve both the effect of blocking the radiant heat from the heater unit and the effect of absorbing the radiant heat from the wafer W (wafer boat 15), it may be more desirable that the heat shielding member 30 is inserted between the wafer boat 15 and the inner tube 14 of the processing vessel 11 closely located to the wafer boat 15.

In addition, in the above-described illustrative embodiment, a diffusion process, a film forming process and an oxidation process are mentioned as examples of the heat treatment. However, the heat treatment in accordance with the illustrative embodiment may include various other processes involving heating, such as an annealing process, a quality modification (reforming) process and an etching process. Further, in the heat treatment in accordance with the illustrative embodiment, the gas supply is not essential. Moreover, although the illustrative embodiment has been described for the case of using a semiconductor wafer as a substrate, the substrate may not be particularly limited to the semiconductor wafer. By way of example, depending on a process to be performed, various types of substrates such as a sapphire substrate, a ZnO substrate and a glass substrate may be employed.

What is claimed is:

1. A substrate cooling device for cooling a plurality of substrates heat-treated in a heat treatment apparatus including a substrate holding member for holding the substrates; a processing vessel for accommodating the substrate holding member therein; a heating member disposed to surround the substrate holding member and to heat the substrates by radiant heat; and an elevating device for moving the substrate holding member between an inside of the processing vessel and an outside of the processing vessel, the heat treatment apparatus performing a heat treatment on the substrates held on the substrate holding member by the heating member, the substrate cooling device comprising:
a cylindrical heat shielding member configured to be movable between an insertion position where the heat shielding member is inserted between the substrate holding member and the heating member and an unloading position where the heat shielding member is unloaded from the insertion position, and configured to block radiant heat toward the substrates after completing the heat treatment; and
an air cooling port provided at the outside of the processing vessel,
wherein the heat shielding member comprises two half-cylindrical members that are assembled and separated at the unloading position,
the two half-cylindrical members are movable between a retreat position where the two half-cylindrical members are separately positioned apart from each other and an assembly position where the two half-cylindrical members are assembled to form the cylindrical heat shielding member,
the heat shielding member assembled at the assembly position is moved between the unloading position and the insertion position, and
an outer surface of the heat shielding member is made of a material having a relatively low emissivity and an inner surface of the heat shielding member is made of a material having a relatively high emissivity.

2. The substrate cooling device of claim 1, wherein the air cooling port has a cooling gas supply device configured to supply a cooling gas to the substrate holding member.

3. The substrate cooling device of claim 1, further comprising:
supporting members for respectively supporting the half-cylindrical members of the heat shielding member,
wherein heat of the half-cylindrical members is discharged via the supporting members when the assembled half-cylindrical members are inserted between the heating member and the substrate holding member within the processing vessel.

4. The substrate cooling device of claim 3,
wherein the supporting members are made of aluminum nitride or alumina.

5. The substrate cooling device of claim 1,
wherein the material having the relatively low emissivity for forming the outer surface of the heat shielding member is quartz or tungsten, and
the material having the relatively high emissivity for forming the inner surface of the heat shielding member is aluminum nitride or alumina.

6. The substrate cooling device of claim 2,
wherein a length of the heat shielding member is set so as not to hinder a supply of the cooling gas from the cooling gas supply device when the heat shielding member is unloaded to the unloading position.

7. The substrate cooling device of claim 2,
wherein the heat shielding member has one or more holes through which the cooling gas from the cooling gas supply device passes, so that the cooling gas is supplied to the substrates held on the substrate holding member.

8. The substrate cooling device of claim 7,
wherein the one or more holes are formed only at a region of the heat shielding member that obstructs the supply of the cooling gas from the cooling gas supply device.

9. A substrate cooling method for cooling a plurality of substrates heat-treated in a heat treatment apparatus including a substrate holding member for holding the substrates; a processing vessel for accommodating the substrate holding member therein; a heating member disposed to surround the substrate holding member and to heat the substrates by radiant heat; and an elevating device for moving the substrate holding member between an inside of the processing vessel and an outside of the processing vessel, the heat treatment apparatus performing a heat treatment on the substrates held on the substrate holding member by the heating member, the substrate cooling method comprising:
inserting a cylindrical heat shielding member between the substrate holding member within the processing vessel and the heating member after completing the heat treatment, the cylindrical heat shielding member including an outer surface made of a material having a relatively low emissivity and an inner surface made of a material having a relatively high emissivity;
performing radiative cooling of the heat-treated substrates held on the substrate holding member by blocking radiant heat toward the substrate;
unloading the substrate holding member into an air cooling port provided at the outside of the processing vessel; and
performing air cooling of the substrates.

10. A heat treatment apparatus comprising:
a substrate holding member configured to hold a plurality of substrates;
a processing vessel configured to accommodate the substrate holding member therein;
a heating member disposed to surround the substrate holding member and configured to heat the substrates by radiant heat;
an elevating device configured to move the substrate holding member between an inside of the processing vessel and an outside of the processing vessel; and
a substrate cooling device configured to cool the substrates after performing a heat treatment on the substrates,
wherein the substrate cooling device comprises:
a cylindrical heat shielding member configured to be movable between an insertion position where the heat shielding member is inserted between the substrate holding member and the heating member and an unloading position where the heat shielding member is unloaded from the insertion position, and configured to block radiant heat toward the substrates after completing the heat treatment; and
an air cooling port provided at the outside of the processing vessel,
wherein the heat shielding member comprises two half-cylindrical members that are assembled and separated at the unloading position,
the two half-cylindrical members are movable between a retreat position where the two half-cylindrical members are separately positioned apart from each other and an assembly position where the two half-cylindrical members are assembled to form the cylindrical heat shielding member,
the heat shielding member assembled at the assembly position is moved between the unloading position and the insertion position, and
an outer surface of the heat shielding member is made of a material having a relatively low emissivity and an inner surface of the heat shielding member is made of a material having a relatively high emissivity.
